(19) United States
(12) Patent Application Publication
(10) Pub. No.: US 2004/0175560 A1
(43) Pub. Date: Sep. 9, 2004

(54) Porous polyester film

(76) Inventors: Chang-Ho Suh, Daegn-si (KR); Ki-Bong Suh, Kumi-si (KR); Sang-Pil Kim, Kumi-si (KR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/354,172

(22) Filed: Jan. 30, 2003

(51) Int. Cl. B32B 3/26; B32B 9/00

(52) U.S. Cl. 428/317.9; 428/304.4; 428/318.4

(57) ABSTRACT

Disclosed is a biaxially stretched polyester film which can be used in a wide range of industrial applications such as printing, imaging, advertising and display. The polyester film has a three-layered structure (A/B/C) comprising: (A) a photic layer of a polyester resin having a 60 degree gloss of 100% or more; (B) a layer containing 3 to 30% by weight of a thermoplastic resin incompatible with the polyester resin, 30% by weight of inorganic particles and 0.5% by weight of a fluorescent whitening agent; and (C) an aphotic layer of a polyester resin having a 60 degree gloss of 50% or less, and a coating layer applied on at least one surface of the film.

### BACKGROUND OF THE INVENTION

1. Field of the Invention

The present invention relates to a porous biaxially stretched polyester film. More particularly, the present invention relates to a biaxially stretched polyester film, which contains a plurality of micropores, is opaque and has different surface characteristics at the front and back surfaces thereof so that it can be used in a wide range of industrial applications such as printing, imaging, advertising and display.

2. Background of the Related Art

Polyester, particularly polyethylene terephthalate, has excellent physical and chemical properties, and hence, is widely used for polymer-processed products. In view of the development of film applications, particle-filled polyester film are developed as substitutes for labels, cards, white boards, photo papers, imaging papers, and the like. Synthetic paper, which is mainly made of a synthetic resin, is excellent in water resistance, wet size stability, surface smoothness, gloss and sharpness of print and mechanical strength, as compared to natural paper. A white film used for the synthetic paper includes polyolefin films with a plurality of micropores therein, which are produced by forming a sheet comprising an olefinic resin as a main ingredient, an inorganic filler and a small amount of additives, followed by biaxially stretching, or polyester films with a plurality of micro-voids therein, which are produced by forming a sheet comprising a polyester resin and a thermoplastic resin incompatible with the polyester resin, followed by biaxially stretching.

The method for producing a porous film by filling an appropriate amount of a thermoplastic resin incompatible with a polyester resin in a matrix and using a stretching mechanism has been well known to the art and the commonly used thermoplastic resin includes polyolefins, polystyrene, etc. For example, GB1195153 proposed a method for producing a biaxially stretched film comprising polyethylene terephthalate with 0.01 to 5% by weight of polyamide or polypropylene. U.S. Pat. No. 3,579,609 discloses a biaxially stretched film comprising polyethylene terephthalate as a main ingredient with up to 40% of a polymeric material selected from polyolefinic polymers of polyethylene, polypropylene, polybutylene, polymethylpentene, copolymers of ethylenevinyl acetate and polytetramethylene oxide. U.S. Pat. No. 3,640,944 discloses a biaxially stretched film comprising polyethylene terephthalate as a main ingredient with 1 to 30% by weight of a polymeric additive such as polysulfone and polymethylpentene and 0.2 to 3% by weight of a light absorber. U.S. Pat. No. 3,944,699 discloses a method for producing a film comprising polyethylene terephthalate with 3 to 27% by weight of polyethylene or polypropylene. GBP 1563591 discloses a polyester film containing 5 to 50% by weight of barium sulfate having an average particle size of 0.5 to 10 μm and polyolefin as a poreforming agent dispersed therein.

KR 1994-0011167 discloses a film comprising microcell type uni- or biaxially stretched polyester film and a coating applied on either one or both sides of the polyester film, in which the coating comprises at least one compound selected from thermoplastic polyesters soluble in an organic solvent; water-dispersable thermoplastic polyesters containing sulfonate; alkyd type polyesters; acrylic modified polyesters; polyurethane resins which are soluble in an organic solvent or water-dispersible; polyisocyanates; terminal-blocked polyurethane resins; vinyl resins which are soluble in an organic solvent or water-dispersible; epoxy resins; silicone resins; urea type resins; and melamine resins. KR 1996-0004143 describes a polyester film with voids comprising a polyester and a thermoplastic resin and characterized in that the void ratio up to 3 μm of the thickness of the outer layer is 4% by volume and the average void ratio of the film is between 8% by volume and 50% by volume. KR 2000-0023359 discloses a laminated porous polyester film comprising a porous polyester layer (A layer) and at least one polyester layer disposed on at least one side of the A polyester layer which contains white inorganic particles having a density of 0.05 to 0.44 g/m³, in which the A layer has a density of 0.5 to 1.2 cm³ and the B layer has a density of 1.1 g/cm³ or more, which is at least 0.1 g/cm³ greater than that of the A layer. KR2000-0025195 discloses a white porous polyester film comprising a polyester resin containing 60% by weight of ethylene terephthalate, 5 to 35% by weight of a polyolefin resin having a melt index of 1.0 to 25 g/10 min and 0.1 to 2.5% by weight of an antistatic agent. KR2000-0027216 discloses a multi-layered white porous polyester film as a substitute for paper comprising a middle layer (B layer) composed of a resin mixture of 65 to 95% by weight of a polyester resin containing inorganic particles and 5 to 35% by weight of a polyolefin resin and 0.3 to 2.0% by weight, based on the total weight of the resin mixture, of an elastomer copolymer and a surface layer of a polyester resin containing inorganic particles disposed on at least one surface of the middle layer, in which the film is at least uniaxially stretched. KR2000-0027217 discloses a method for producing a multi-layered white porous polyester film by mixing 65 to 95% by weight of a polyester resin and 5 to 35% by weight of a polyolefin resin to form a resin mixture and adding 0.2 to 3.0% by weight of a polyethylene copolymer. KR2000-0027218 discloses a method for white porous polyester film as a substitute for paper by mixing a polyester resin composed of polypropylene terephthalate, polybutylene terephthalate or a combination thereof and inorganic particles and a polyolefin resin to form a resin mixture and adding 0.3 to 2.0% by weight, based of the total weight of the resin mixture, of an elastomer copolymer. KR2000-0027220 discloses a method for producing a white porous polyester film as a substitute for paper comprising steps of mixing 65 to 95% by weight of a polyester resin containing inorganic particles and having a melting point of 170 to 230° C. and 5 to 35% by weight of a polyolefin resin to form a resin mixture, adding 0.3 to 2.0% by weight, based on the total weight of the resin mixture, of an elastomer copolymer to the resin mixture and melting, extruding and stretching the mixture. KR2000-0061237 discloses a method for producing a white polyester film comprising a polyester resin comprising 70 to 90 weight parts of ethylene terephthalate and 10 to 30 weight parts of ethylene naphthalate with an olefin resin and inorganic particles (spherical calcium carbonate), characterized by coating an aqueous coating solution mainly consisting of an water soluble polyester containing sulfonate and a polyurethane on at least one surface of the white polyester film. KR2002-0049760 discloses a white porous polyester film comprising a polyester resin layer (A layer) containing at least one of inorganic particles, a fluorescent whitening agent and various additives and a polyester resin layer (B layer) comprising a polyolefin resin and 1 to 25 weight parts of spherical glass beads having an average particle size of 1 to 20 μm, in which the ratio between the thicknesses of respective layers (A/B) is 0.01 to 0.2. KR2002-0049762 discloses a white porous polyester film produced by stretching a resin mixture of a polyester resin containing a polyolefin resin with at least one of inorganic particles, a fluorescent whitening agent and various additives, in which 1 to 15 weight parts of spherical glass beads having an average particle size of 1 to 20 μm are added.

Japanese Patent Application Laid-Open No. Hei 8-252857 discloses a white polyester film composed of a polyester resin comprising polyester, and polyolefin, polyalkylene glycol or copolymers thereof and the other polyester layer. Japanese Patent Application Laid-Open No. Hei 10-338763 discloses a polyester film containing micro voids produced by biaxially stretching a polymeric mixture of a polyester and a thermoplastic incompatible with the polyester, followed by a heat treatment, in which the thermoplastic resin incompatible with the polyester includes at least a polystyrene resin, polymethylpentene resin and polypropylene resin and the content of the polystyrene resin, the polymethylpentene resin and the polypropylene resin satisfy a specific relation. Japanese Patent Application Laid-Open No. Hei 11-170462 discloses a laminated white polyester film containing titanium dioxide particles, barium sulfate particles and a fluorescent whitening agent and having an apparent density 0.5 to 1.3 g/cm³. Japanese Patent Application Laid-Open No. Hei 11-199694 discloses a polyester film with a plurality of voids derived from a thermoplastic resin incompatible with polyester, in which the film has an apparent specific gravity of 1.3 or less and at least one surface thereof has a cohesive failure index of 3 or less and a gloss of 20% or more. Japanese Patent Application Laid-Open No. Hei 11-240972 discloses a polyester film with a plurality of voids derived from a thermoplastic resin incompatible with polyester, in which the film has an apparent specific gravity of 1.3 or less and at least one surface thereof has a dynamic hardness of 5.0 or less and a gloss of 20% or more. Japanese Patent Application Laid-Open No. Hei 11-34263 discloses a polyester film with voids comprising a polyester film layer containing a plurality of microvoids derived from a thermoplastic resin incompatible with polyester (A layer) and a polyester film layer containing a plurality of microvoids derived from inorganic particles having an average particle diameter of less than 1 μm (B layer), in which the void ratio in the B layer is 20% by volume or more, the B layer has a thickness of 1 to 20 μm, which is less than 30% of the total thickness of the film, and the film has an apparent specific gravity of 1.3 or less. Japanese Patent Application No. 2000-169610 discloses a polyester film with micropores comprising a polyester resin and a thermoplastic resin incompatible with the polyester resin, characterized by having a pore distribution modal diameter (based on volume) of 0.01 to 0.15 μm. Japanese Patent Application No. 2001-288291 discloses a polyester film with voids comprising mainly a polyester resin, characterized by having a void number density (based on volume) of 0.20/μm or more. Japanese Patent Application No. 2001-341259 discloses a composite polyester film with voids comprising a void containing layer of a composition comprising a polyester resin and a thermoplastic resin incompatible with the polyester resin (A layer) and a polyester film disposed on at least one surface of the A layer by co-extrusion and containing 5 to 45% by weight of white inorganic particles (B layer), in which the film has an apparent specific gravity of 0.85 to 1.35 and a void number density (void number in the thickness direction of the A layer/the thickness of the A layer) is 0.20 or more. Japanese Patent Application No. 2001-348450 discloses a coated polyester film with voids for label print comprising a void-containing polyester base film of a composition comprising a polyester resin and a thermoplastic resin incompatible with the polyester resin and a easy printable layer applied on at least one surface of the base film, in which the base film has a void number density of less than 0.20/μm and 60-degree specular gloss (G1) and 75-degree specular gloss (G2) of the film satisfy a certain relation. Japanese Patent Application No. 2002-37900 discloses a polyester film comprising a polyester resin and a thermoplastic resin incompatible with the polyester resin and containing a plurality of voids distributed in the polyester resin which are derived from the thermoplastic resin incompatible with the polyester resin, characterized in that the film has an average spectral reflectance of 98.0% or more against an electromagnetic wave of 450 nm and absolute value of difference between spectral reflectances on the section of the film and the specular surface against an electromagnetic wave of 450 nm is less than 6.0%.

Recently, application of the ink-jet printing method in various facsimile or printer apparatuses and plotter devices makes a rapid progress since the ink-jet printing method shows a low noise level and can perform recording operation at a high speed with full colors and moreover at a low cost. Meanwhile, as the high speed recording with full colors is realized, there is demand for high quality recording sheets and thus, investigation of recording sheets are often conducted. For example, in order to enhance sharpness of a printed image, a color b value and surface gloss of synthetic paper or plastic film used as a recording sheet are studied.

The present invention is to provide a highly functional white film, which can be used in applications including printing, imaging, advertising and display. In such graphic applications, surface properties of the white film are of importance. In other words, the preference and quality of products significantly vary depending on the color and gloss, etc. of the surface. The gloss of the products varies depending on physical properties of a film, or the surface design of a substrate, and the surface properties are accomplished by artificially controlling the surface roughness of the substrate. The gloss of the substrate has an effect on a subsequent process such as printing, and also on the quality of the products. An object of the present invention is to provide a multi-functional and high-functional white film, which can be henceforth used in various applications such as electrical and electronic materials.

### SUMMARY OF THE INVENTION

Thus, it is an object of the present invention to provide a multi-functional and high-functional white film, which can be used in various applications such as electrical and electronic materials.

### BRIEF DESCRIPTION OF THE DRAWINGS

The above and other objects, features and advantages of the present invention will be apparent from the following detailed description of the preferred embodiments of the invention in conjunction with the accompanying drawing, in which:

FIG. 1 is a cross-section view showing an embodiment of the laminated white film according to the present invention.

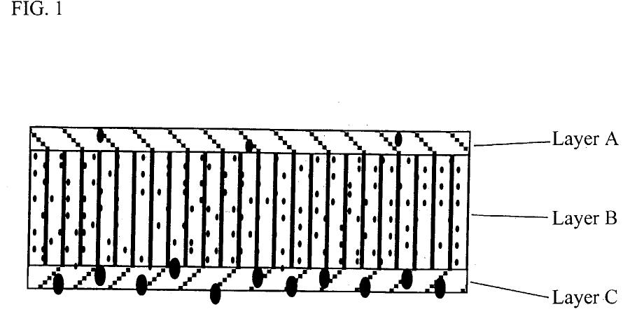

### DETAILED DESCRIPTION OF THE PREFERRED EMBODIMENT

To achieve the above object, in one embodiment, the present invention provides a laminated white polyester film having a three-layered structure (A/B/C) comprising: (A) a photic layer of a polyester resin having a 60 degree gloss of 100% or more; (B) a layer containing 3 to 30% by weight of a thermoplastic resin incompatible with the polyester resin, 30% by weight of inorganic particles and 0.5% by weight of a fluorescent whitening agent; and (C) an aphotic layer of a polyester resin having a 60 degree gloss of 50% or less, and a coating layer applied on at least one surface of the film to provide easy printability, antistatic property and releasability. Particularly, in order to provide easy printability to the film, the coating layer is formed by applying an aqueous coating solution mainly comprising acrylics, polyesters or polyurethanes.

The production of the laminated white polyester film can be carried out using a co-extrusion technique based on a technique for the production of a mono-layered white polyester film. The technique for the production of the white film requires an advanced process technique in addition to a technique for the production of a general polyester film. In particular, since a wide polyester production line is generalized nowadays, process technology development must be first achieved in order to produce a white polyester film filled with large amounts of inorganic particles. Since titanium dioxide filled in the polyester film in a large amount may cause a reduction in the intrinsic viscosity of a polyester matrix, particular care should be taken to maintain the intrinsic viscosity of the polyester matrix at a suitable level. If the viscosity is too low, breakage will occur with high possibility upon film production. Since the inorganic particles contained in a large amount act as a nucleating agent in a polymer melt during a casting process, a crystallization controlling technique is required. Furthermore, since these particles limit matrix stretchability, a stretching mechanism different from the one commonly used for a conventional polyester film is required. The average particle size of titanium dioxide used in the present invention is 0.05 to 5 μm, and preferably 0.1 to 0.5 μm. If the particle size is less than 0.05 μm, the dispersibility of particles in a film will be reduced due to particle cohesion. If the particle size is more than 5 μm, the interaction force between particles and between particles and the matrix is weak. As a result, bubbles may be significantly produced during a stretching process, which makes the process unstable. Meanwhile, titanium dioxide is filled in the matrix in an amount of 5 to 30% by weight, and preferably 10 to 20% by weight. If the amount of the titanium dioxide is less than 5% by weight, whiteness will be low and coverage will not reach a suitable value. If the amount is more than 30% by weight, flow characteristics of the polymer will be changed (e.g., a reduction in the swelling phenomenon of a melt, and an increase in the sagging phenomenon of a melt), and stretchability is reduced, thereby making a film producing process difficult. Moreover, the fluorescent whitening agent used in the present invention includes bisbenzoxazoles, and preferably 2,2′-(1,2-ethenediyldi-4,1-phenylene)bisbenzoxazoles. The fluorescent whitening agent is added in an amount of 0.005 to 0.5% by weight, and preferably 0.05 to 0.2% by weight. If the added amount of the fluorescent whitening agent is less than 0.005% by weight, a whitening effect will be insufficient, and if the added amount is more than 0.5% by weight, whiteness will be reduced due to excessive reflectivity.

In order to adjust surface characteristics of the film, in the present invention, the surface roughness of the film is inputted using a co-extrusion technique and an inorganic particle design technique to obtain the desired gloss. The three-layered substrate described in the present invention, each layer of which consists of a material having a flow characteristic different from materials used in other layers is designed so as to solve problems such as extrusion instability by flow mechanisms of the respective materials. The silicon dioxide particles used in the present invention have an average particle size of 1 to 10 μm, preferably 2 to 5 μm. The added amount of the particles are 0.1 to 5% by weight, preferably 0.5 to 1% by weight. If the average particle size is less than 1 μm while the added amount is greater than the upper limit of the foregoing range, or if the added amount is less than 0.1% by weight while the average particle size exceeds the upper limit of the foregoing range, it is impossible to satisfactory quenching effect and print quality. In other hand, addition of particles of a relatively large size (exceeding 10 μm) in a large amount (exceeding 5% by weight) may cause deterioration in film formability.

For measurement of the characteristic property according to the present invention, the 60-degree gloss is determined according to ASTM method D523 and the adhesion is determined according to ASTM method D3359. The adhesion of ink to the film is evaluated by the cross-cut tape test, which is one of two tests described in the ASTM method 3359, that is, the cross-cut tape test and the X-cut tape test. Thus, the examined films are classified according to the grades as follows:

5B: Edges of crosscut area are smooth and no flaking occurs on the squares of the lattice.

4B: Small flakes are detached at intersections of the lattice and the removed area is up to 5%.

3B: Small flakes are detached at edges and intersections and the removed area is between 5% and 15%.

2B: flakes detached along edges and on parts of the squares and the removed area is between 15% and 35%.

1B: flaking in large ribbons and detachment of whole squares has occurred and the removed area is between 35% and 65%.

0B: flaking and detachment are worse than grade 1B and the removed area is more than 65%.

### EXAMPLE 1

A film was prepared using five polyethylene terephthalate-based materials, as follows: PM1, polyethylene terephthalate free of particles. having an intrinsic viscosity of 0.65 dl/g; PM2, polypropylene free of particles having a melt index of 10; PM3, polyethylene terephthalate containing 50% by weight of titanium dioxide having an average particle size of 0.3 μm and 0.15% by weight of a fluorescent whitening agent; PM4, polyethylene terephthalate containing 5% by weight of silicon dioxide having an average particle size of 4 μm; and PM5, polyethylene terephthalate containing 5% by weight of silicon dioxide having an average particle size of 2 μm.

Three compositions were prepared by compounding the ingredients of PM1, PM2, PM3, PM4 and PM5 according to the ratio (% by weight) listed in Table 1, laminated in a feed block as a three-layer construction, extruded through a co-extrusion die and cooled in a casting drum to produce a sheet. The sheet was stretched longitudinally 3.0 times at a temperature of 75 to 130° C. and an aqueous dispersion containing 2.0% by weight of an aqueous acryl emulsion was coated on both sides of the stretched sheet by means of an in-line coater. Then, the sheet was stretched laterally 3.3 times at 90 to 145° C. and subjected to a heat treatment at a temperature in the range of 215 to 235° C. to give a film having an average thickness of 50 μm. Thicknesses of respective layers of the prepared film were 0.05 μm/3 μm/43.9 μm/3 μm/0.05 μm.

TABLE 1

| | | Content (% by weight) | | | | | |
|---|---|---|---|---|---|---|---|
| Example No. | Layer | PM1 | PM2 | PM3 | PM4 | PM5 | |
| Example 1 | A | 90 | 0 | 0 | 0 | 10 | Laminate |
| | B | 80 | 10 | 10 | 0 | 0 | |
| | C | 55 | 0 | 0 | 45 | 0 | |
| Example 2 | A | 90 | 0 | 0 | 0 | 10 | Laminate |
| | B | 80 | 10 | 10 | 0 | 0 | |
| | C | 55 | 0 | 0 | 45 | 0 | |
| Example 3 | A | 90 | 0 | 0 | 0 | 10 | Laminate |
| | B | 80 | 10 | 10 | 0 | 0 | |
| | C | 35 | 0 | 0 | 65 | 0 | |
| Example 4 | A | 90 | 0 | 0 | 0 | 10 | Laminate |
| | B | 80 | 10 | 10 | 0 | 0 | |
| | C | 35 | 0 | 0 | 65 | 0 | |
| Comp. | — | 80 | 10 | 10 | 0 | 0 | Single-layer |
| Example 1 | | | | | | | |
| Comp. | — | 70 | 10 | 10 | 10 | 0 | Single-layer |
| Example 2 | | | | | | | |

### EXAMPLE 2

A film with an average thickness of 50 μm was prepared by following the process of Example 1 and using the composition of ingredients, as listed in Table 1. Thicknesses of respective layers of the prepared film were 0.05 μm/5 μm/39.9 μm/5 μm/0.05 μm.

### EXAMPLE 3

A film with an average thickness of 50 μm was prepared by following the process of Example 1 and using the composition of ingredients, as listed in Table 1. Thicknesses of respective layers of the prepared film were 0.05 μm/3 μm/43.9 μm/3 μm/0.05 μm.

### EXAMPLE 4

A film with an average thickness of 50 μm was prepared by following the process of Example 1 and using the composition of ingredients, as listed in Table 1. Thicknesses of respective layers of the prepared film were 0.05 μm/5 μm/39.9 μm/5 μm/0.05 μm.

### COMPARATIVE EXAMPLE 1

A film was prepared using three polyethylene terephthalate-based materials, as follows: PM1, polyethylene terephthalate free of particles having an intrinsic viscosity of 0.65 dl/g; PM2, polypropylene free of particles having a melt index of 10; and PM3, polyethylene terephthalate containing 50% by weight of titanium dioxide having an average particle size of 0.3 μm and 0.15% by weight of a fluorescent whitening agent.

A sheet was prepared by compounding the ingredients of PM1, PM2 and PM3 according to the ratio (% by weight) listed in Table 1, extruding the mass through a co-extrusion die as a single layer, followed by cooling in a casting drum to produce a sheet. The sheet was stretched longitudinally 3.0 times at a temperature of 75 to 130° C. and an aqueous dispersion containing 2.0% by weight of an aqueous acryl emulsion was coated on both sides of the stretched sheet by means of an in-line coater. Then, the sheet was stretched laterally 3.3 times at 90 to 145° C. and subjected to a heat treatment at a temperature in the range of 215 to 235° C. to give a film having an average thickness of 50 μm.

### COMPARATIVE EXAMPLE 2

A film with an average thickness of 50 μm was prepared by following the process of Comparative example 1 and using the composition of ingredients, as listed in Table 1.

Particle types, contents of particles and additives, and glosses are shown in Table 2 below. Adhesions of ink to films are shown in Table 3 below.

TABLE 2

| | | | Content (% by weight) | | | | |
|---|---|---|---|---|---|---|---|
| Example | | Layer thickness | Titanium | | | | Gloss |
| No. | Layer | (μm) | dioxide | 4 μm silica | 2 μm silica | Polypropylene | (%) |
| Example 1 | Coating | 0.05 | — | — | — | — | 131 |
| | layer | | | | | | |
| | A | 3 | 0 | 0 | 0.1 | 0 | — |
| | B | 43.9 | 5 | 0 | 0 | 10 | — |
| | C | 3 | 0 | 2.25 | 0 | 0 | — |
| | Coating | 0.05 | — | — | — | — | 38 |
| | layer | | | | | | |
| Example 2 | Coating | 0.05 | — | — | — | — | 128 |
| | layer | | | | | | |
| | A | 5 | 0 | 0 | 0.1 | 0 | — |
| | B | 39.9 | 5 | 0 | 0 | 10 | — |
| | C | 5 | 0 | 2.25 | 0 | 0 | — |
| | Coating | 0.05 | — | — | — | — | 27 |
| | layer | | | | | | |
| Example 3 | Coating | 0.05 | — | — | — | — | 133 |
| | layer | | | | | | |
| | A | 3 | 0 | 0 | 0.1 | 0 | — |
| | B | 43.9 | 5 | 0 | 0 | 10 | — |
| | C | 3 | 0 | 3.25 | 0 | 0 | — |
| | Coating | 0.05 | — | — | — | — | 23 |
| | layer | | | | | | |
| Example 4 | Coating | 0.05 | — | — | — | — | 135 |
| | layer | | | | | | |
| | A | 5 | 0 | 0 | 0.1 | 0 | — |
| | B | 39.9 | 5 | 0 | 0 | 10 | — |
| | C | 5 | 0 | 3.25 | 0 | 0 | — |
| | Coating | 0.05 | — | — | — | — | 17 |
| | layer | | | | | | |
| Comp. | — | — | 5 | 0 | 0 | 10 | 74 |
| Example 1 | | | | | | | |
| Comp. | — | — | 5 | 0.5 | 0 | 10 | 44 |
| Example 2 | | | | | | | |

TABLE 3

| | | Adhesion of ink | | | | | | | | | |
|---|---|---|---|---|---|---|---|---|---|---|---|
| | | | | | Solvent | | Solvent | | | | |
| Example | | Binder | Solvent | Binder | TOL/ | Binder | TOL/ | Binder | Solvent | Binder | Solvent |
| No. | Layer | AC | EA | NC | MEK | EVA | IPA/EA | VC-VA | MEK | CAB | MEK |

| | | | | | | |
|---|---|---|---|---|---|---|
| Example 1 | Coating | 4B | 4B | 5B | 4B | 5B |
| | layer | | | | | |
| | A | — | — | — | — | — |
| | B | — | — | — | — | — |
| | C | — | — | — | — | — |
| | Coating | 4B | 4B | 5B | 4B | 5B |
| | layer | | | | | |
| Example 2 | Coating | 4B | 4B | 5B | 4B | 5B |
| | layer | | | | | |
| | A | — | — | — | — | — |
| | B | — | — | — | — | — |
| | C | — | — | — | — | — |
| | Coating | 4B | 4B | 5B | 4B | 5B |
| | layer | | | | | |
| Example 3 | Coating | 4B | 4B | 5B | 4B | 5B |
| | layer | | | | | |
| | A | — | — | — | — | — |
| | B | — | — | — | — | — |
| | C | — | — | — | — | — |
| | Coating | 4B | 4B | 5B | 4B | 5B |
| | layer | | | | | |
| Example 4 | Coating | 4B | 4B | 5B | 4B | 5B |
| | layer | | | | | |
| | A | — | — | — | — | — |
| | B | — | — | — | — | — |
| | C | — | — | — | — | — |
| | Coating | 4B | 4B | 5B | 4B | 5B |
| | layer | | | | | |
| Comp. | — | 1B | 1B | 1B | 1B | 1B |
| Example 1 | | | | | | |
| Comp. | — | 1B | 1B | 1B | 1B | 1B |
| Example 2 | | | | | | |

AC: Acryls, EA: Ethyl acetate, NC: Nitro cellulose, TOL: Toluene, MEK: Methylethylketone, EVA: Ethylene vinyl acetate, IPA: Isopropyl alcohol, VC-VA: Vinyl chloride-vinyl acetate, CAB: cellulose acetate butylate

What is claimed is:

1. A porous polyester film having a three-layered structure (A/B/C) comprising: (A) a glossy layer of a polyester resin having a 60 degree gloss of 100% or more; (B) a layer containing 3 to 30% by weight of a thermoplastic resin incompatible with the polyester resin, below 30% by weight of inorganic particles and below 0.5% by weight of a fluorescent whitening agent; and (C) a matte layer of a polyester resin having a 60 degree gloss of 50% or less, and a coating layer applied on at least one surface of the film to provide easy printability, antistatic property and releasability.

2. The porous polyester film according to claim 1, wherein the coating layer is formed by applying an aqueous coating solution mainly comprising acrylics, polyesters or polyurethanes in order to provide easy printability to the film.

3. The porous polyester film according to claim 1, wherein the thermoplastic resin incompatible with the polyester resin comprises polyolefine type resins.

4. The porous polyester film according to claim 1, wherein the inorganic particles have an average particle size of 0.1 to 10 μm.

5. The porous polyester film according to claim 1, wherein the inorganic particles comprise at least one selected from the group consisting of titanium dioxide, calcium carbonate, silica, kaolin, mica, talc and barium sulfate.

6. The porous polyester film according to claim 1, the layer of (A) contains up to 0.5% weight of silica particles having an average particle size of 0.05 to 5 μm.

7. The porous polyester film according to claim 1, wherein the layer of (C) contains 0.5 to 10% by weight of silica particles having an average particle size of 0.5 to 20 μm.

8. The porous polyester film according to claim 1, wherein the fluorescent whitening agent comprises bisbenzoxazoles.

9. The porous polyester film according to claim 1, wherein the coating layer has a thickness of 0.01 to 1 μm.
